(19) United States
(12) Patent Application Publication
(10) Pub. No.: US 2014/0278148 A1
(43) Pub. Date: Sep. 18, 2014

(54) VIRTUAL IN-LINE INSPECTION OF WALL LOSS DUE TO CORROSION IN A PIPELINE

(71) Applicants: Eric Ziegel, Houston, TX (US); Richard Bailey, Ashtead Surrey (GB); Kip Sprague, Naperville, IL (US)

(72) Inventors: Eric Ziegel, Houston, TX (US); Richard Bailey, Ashtead Surrey (GB); Kip Sprague, Naperville, IL (US)

(21) Appl. No.: 13/800,245

(22) Filed: Mar. 13, 2013

(51) Int. Cl. F17D 5/00

(52) U.S. Cl. CPC F17D 5/00
USPC 702/34

(57) ABSTRACT

In accordance with aspects of the present disclosure, a computer-implemented method for predicting a material deterioration state of a pipeline is disclosed. The computer-implemented method can be stored on a tangible and non-transitory computer readable medium and arranged to be executed by one or more processors that cause the one or more processors to receive data related to the pipeline, create a mathematical model of pipeline wall corrosion and use the mathematical model to determine sections of pipeline that should be physically inspected.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND

This disclosure is in the field of pipeline inspection, and is more specifically directed to predicting internal corrosion of pipeline sections so that physical inspection can focus on at-risk portions of the pipeline.

A section of a pipeline can be inspected using an in-line inspection device, also referred to as a “smart pig.” Smart pigs are inserted into pipelines in order to measure corrosion activity experienced by an interior or exterior surface of the pipeline. This patent is focused on internal corrosion. Smart pigs can be self-propelled or move along according to the flow of material in the pipeline. Smart pigs can utilize acoustic resonance, calipers, magnetic flux leakage instruments or electromagnetic acoustic transducers to detect corrosion. Smart pigs can record their measurements using internal memory. Smart pigs also include odometers or other instrumentation for determining their position within the pipeline at a given point in time. Accordingly, smart pigs are capable of detecting where and to what extent internal corrosion has occurred in a pipeline. These data are used to plan the amount of chemical inhibition that is needed for the pipeline and to guide more detailed inspection of the critical areas with more accurate inspection technologies.

The pipeline must be opened in order to insert a smart pig, which requires a launching conduit in the pipeline. Many pipelines do not include pig launching conduits. Furthermore, a technician can be exposed to hostile environments to which the pipeline is exposed, as well as to the materials being transported by the pipeline. Because oil and gas reservoirs are increasingly being processed in extreme environments, such as the North Slope in Alaska, the pipelines that support them are also subject to these conditions. Moreover, the materials being transported by the pipeline are usually under extreme temperatures and pressures, which can also be hazardous to the on-site technician.

Maintaining the integrity of pipelines is a fundamental function in maintaining the economic success and minimizing the environmental impact of modern oil and gas production fields and systems. In addition, pipeline integrity is also of concern in other applications, including factory piping systems, municipal water and sewer systems, and the like. Similar concerns exist in the context of other applications, such as production casing of oil and gas wells. As is well known in the field of pipeline maintenance, corrosion and ablation of pipeline material, from the fluids flowing through the pipeline, will reduce the thickness of pipeline walls over time. In order to prevent pipeline failure, it is of course important to monitor the extent to which pipeline wall thickness has been reduced, so that timely repairs can be made.

### BRIEF SUMMARY

In accordance with some aspects of the present disclosure, a computer-implemented method of selecting at least one portion of oil pipeline for physical inspection is disclosed. The method can include selecting a first section of oil pipeline, collecting and electronically storing geometric configuration data of the first section of oil pipeline, collecting and electronically storing chemical composition data of a product flowing through the first section of oil pipeline, the chemical composition data reflecting at least each of a first plurality of days, collecting and electronically storing chemical inhibition data of a corrosion inhibiting chemical introduced to the first section of oil pipeline, the chemical inhibition data reflecting at least each of the first plurality of days and collecting and electronically storing internal pipeline state data of the first section of oil pipeline, the internal pipeline state data reflecting a time subsequent to the first plurality of days. The method can further include forming a mathematical model of a state of the first section of oil pipeline, the mathematical model accepting as inputs at least the geometric configuration data of the first section of oil pipeline, the chemical composition data of the product flowing through the first section of oil pipeline, the chemical inhibition data of the corrosion inhibiting chemical introduced to the first section of oil pipeline, and the internal pipeline state data of the first section of oil pipeline. The method can further include collecting and electronically storing geometric configuration data of a second section of oil pipeline, collecting and electronically storing chemical composition data of a product flowing through the second section of oil pipeline, the chemical composition data reflecting at least each of a second plurality of days, collecting and electronically storing chemical inhibition data of a corrosion inhibiting chemical introduced to the second section of oil pipeline, the chemical inhibition data reflecting at least each of the second plurality of days and inputting at least the geometric configuration data of the second section of oil pipeline, the chemical composition data of a product flowing through the second section of oil pipeline and the chemical inhibition data of a corrosion inhibiting chemical introduced to the second section of oil pipeline to the mathematical model. The method can further include executing the mathematical model to produce an estimate of an internal pipeline state of the second section of oil pipeline, determining that the estimate of the internal pipeline state of the second section of oil pipeline exceeds a threshold, and physically inspecting the second section of oil pipeline in response to the determining.

### BRIEF DESCRIPTION OF THE SEVERAL VIEWS OF THE DRAWING

FIG. 1 is a schematic diagram of an example of a production field in connection with which the embodiments of the disclosure can be used.

FIG. 2 is a schematic diagram of a smart pig being inserted in a pipeline.

FIG. 3 is a schematic diagram of an evaluation system programmed to carry out an embodiment of the disclosure.

FIG. 4 is a flow diagram illustrating an example method according to an embodiment of the disclosure.

### DETAILED DESCRIPTION

The present disclosure will be described in connection with its embodiments in connection with a method and system for monitoring and evaluating pipeline integrity in a production field and system for oil and gas. However, it is contemplated that this disclosure can also provide important benefit in other applications, including the monitoring and evaluating of production casing integrity in oil and gas wells, and the monitoring and evaluating of pipeline integrity in other applications such as water and sewer systems, natural gas distribution systems on the customer side, and factory piping systems, to name a few. Accordingly, it is to be understood that the following description is provided by way of example only, and is not intended to limit the true scope of this disclosure as claimed.

FIG. 1 is a schematic diagram of an example of a production field in connection with which the embodiments of the disclosure can be used. An example of an oil and gas production field, including surface facilities, in connection with which an embodiment of the disclosure can be utilized, is illustrated in a simplified block form. In this example, the production field includes multiple wells 4, deployed at various locations within the field, from which oil and gas products are to be produced in the conventional manner. While a number of wells 4 are illustrated in FIG. 1, it is contemplated that modem production fields in connection with which the present disclosure can be utilized will include many more wells than those wells 4 depicted in FIG. 1. In this example, each well 4 can be connected to an associated one of multiple drill sites 2 in its locale by way of a pipeline 5. By way of example, eight drill sites 2₀ through 2₇ are illustrated in FIG. 1; it is, of course, understood by those in the art that more or less than eight drill sites 2 can be deployed within a production field. Each drill site 2 can support wells 4; for example drill site 2₃ is illustrated in FIG. 1 as supporting forty-two wells 4₀ through 4₄₁. Each drill site 2 gathers the output from its associated wells 4, and forwards the gathered output to central processing facility 6 via one of pipelines 5. Eventually, central processing facility 6 can be coupled into an output pipeline, which in turn can be coupled into a larger-scale pipeline facility along with other central processing facilities 6.

In the example of oil production from the North Slope of Alaska, the pipeline system partially shown in FIG. 1 connects into the Trans-Alaska Pipeline System, along with many other wells 4, drilling sites 2, pipelines 5, and processing facilities 6. Thousands of individual pipelines can be interconnected in the overall production and processing system connecting into the Trans-Alaska Pipeline System. As such, the pipeline system illustrated in FIG. 1 can represent only a portion of an overall production pipeline system.

While not suggested by the schematic diagram of FIG. 1, in actuality pipelines 5 vary widely from one another in construction and geometry, in parameters including diameter, nominal wall thickness, overall length, numbers and angles of elbows and curvature, location (underground, above-ground, or extent of either placement), to name a few. In addition, parameters regarding the fluid carried by the various pipelines 5 also can vary widely in composition, pressure, flow rate, and the like. These variations among pipeline construction, geometry, contents, and nominal operating condition affect the extent and nature of corrosion and ablation of the pipeline walls, as known in the art. In addition, it has been observed, in connection with this disclosure, that the distribution of wall loss (e.g., wall thickness loss, measured at the point of deepest corrosion) along pipeline length also varies widely among pipelines in an overall production field, with no readily discernible causal pattern relative to construction or fluid parameters.

FIG. 2 is a schematic diagram of smart pig 21 being inserted in a pipeline 25. While FIG. 2 depicts opening pipeline 25 to insert smart pig 21, other techniques exist for smart pig deployment. So-called pig launchers, which do not require completely opening the pipeline, can be used in the alternative. Nevertheless, both pipeline opening and pig launchers are associated with high costs, potential danger and usage of resources. Furthermore, not every pipeline can accommodate a smart pig. Pipelines that lack smooth transitions between pipe segments or sufficiently large turn radii, and pipelines that incorporate butterfly valves, cannot generally accommodate smart pigs.

FIG. 3 is an example diagram, in block form, of an evaluation system programmed to carry out an embodiment of the disclosure. Prediction system 10 performs the operations described in this specification to determine a wall loss due to corrosion within a pipeline. Of course, the particular architecture and construction of a computer system useful in connection with this disclosure can vary widely. For example, prediction system 10 can be realized by a computer based on a single physical computer, or alternatively by a computer system implemented in a distributed manner over multiple physical computers. Accordingly, the architecture illustrated in FIG. 3 is provided merely by way of example.

As shown in FIG. 3, prediction system 10 can include central processing unit 15, coupled to a system bus. Input/output interface 11 can also be coupled to a system bus, which refers to those interface resources by way of which peripheral functions P (e.g., keyboard, mouse, display, etc.) interface with the other constituents of evaluation system 10. Central processing unit 15 refers to the data processing capability of prediction system 10, and as such can be implemented by one or more CPU cores, co-processing circuitry, and the like. The particular construction and capability of central processing unit 15 can be selected according to the application needs of prediction system 10, such needs including, at a minimum, the carrying out of the functions described in this specification, and also including such other functions as can be desired to be executed by a computer system. In the architecture of prediction system 10 according to this example, data memory 12 and program memory 14 can be coupled to a system bus, and can provide memory resources of the desired type useful for their particular functions. Data memory 12 can store input data and the results of processing executed by central processing unit 15, while program memory 14 can store the computer instructions to be executed by central processing unit 15 in carrying out those functions. Of course, this memory arrangement is only an example, it being understood that data memory 12 and program memory 14 can be combined into a single memory resource, or distributed in whole or in part outside of the particular computer system shown in FIG. 3 as implementing evaluation system 10. Typically, data memory 12 can be realized, at least in part, by high-speed random-access memory in close temporal proximity to central processing unit 15. Program memory 14 can be realized by mass storage or random access memory resources in the conventional manner, or alternatively can be accessible over network interface 16 (i.e., if central processing unit 15 is executing a web-based or other remote application).

Network interface 16 can be a conventional interface or adapter by way of which prediction system 10 accesses network resources on a network. As shown in FIG. 3, the network resources to which prediction system 10 has access via network interface 16 can include those resources on a local area network, as well as those accessible through a wide-area network such as an intranet, a virtual private network, or over the Internet. In this embodiment of the disclosure, sources of data processed by prediction system 10 are available over such networks, via network interface 16. Library 20 can store any, or a combination, of historical, current data and measurements for selected pipelines in the overall production field or pipeline system; library 20 can reside on a local area network, or alternatively can be accessible via the Internet or some other wider area network. It is contemplated that library 20 can also be accessible to other computers associated with the operator of the particular pipeline system. In addition, as shown in FIG. 3, measurement inputs 18 for other pipelines in the production field or pipeline system can be stored in a memory resource accessible to prediction system 10, either locally or via network interface 16.

Of course, the particular memory resource or location in which the measurements 18 can be stored, or in which library 20 can reside, can be implemented in various locations accessible to evaluation system 10. For example, these data can be stored in local memory resources within prediction system 10, or in network-accessible memory resources as shown in FIG. 3. In addition, these data sources can be distributed among multiple locations, as known in the art. Further in the alternative, the measurements corresponding to measurements 18 and to library 20 can be input into prediction system 10, for example by way of an embedded data file in a message or other communications stream. It is contemplated that those skilled in the art will be able to implement the storage and retrieval of measurements 18 and library 20 in a suitable manner for each particular application.

According to this embodiment of the disclosure, as mentioned above, program memory 14 can store computer instructions executable by central processing unit 15 to carry out the functions described in this specification, by way of which measurements 18 for a given pipeline are analyzed to determine a predict a particular level of corrosion in the pipeline. These computer instructions can be in the form of one or more executable programs, or in the form of source code or higher-level code from which one or more executable programs are derived, assembled, interpreted or compiled. Any one of a number of computer languages or protocols can be used, depending on the manner in which the desired operations are to be carried out. For example, these computer instructions can be written in a conventional high level language, either as a conventional linear computer program or arranged for execution in an object-oriented manner. These instructions can also be embedded within a higher-level application. It is contemplated that those skilled in the art having reference to this description will be readily able to realize, without undue experimentation, this embodiment of the disclosure in a suitable manner for the desired installations. Alternatively, these computer-executable software instructions can, according to the preferred embodiment of the disclosure, be resident elsewhere on the local area network or wide area network, accessible to prediction system 10 via its network interface 16 (for example in the form of a web-based application), or these software instructions can be communicated to prediction system 10 by way of encoded information on an electromagnetic carrier signal via some other interface or input/output device.

FIG. 4 is a flow diagram illustrating an example method according to an embodiment of the disclosure. In general, a virtual or soft smart pig is described that can make an estimate of internal pipeline corrosion (e.g., wall loss due to corrosion). By monitoring the predicted result for the virtual smart pig, it is possible to provide the evidence to encourage inspection teams to physically inspect select pipeline portions. Accordingly, cost, time and risk associated with working on pipelines carrying pressurized fluids (potentially also toxic and flammable) are reduced by focusing on at-risk pipeline portions only. Furthermore, sections of pipeline that cannot accommodate physical smart pigs can be virtually inspected using certain embodiments that estimate internal pipeline corrosion.

Certain embodiments provide a “virtual smart pig,” which includes a mathematical model to predict wall loss due to corrosion that would be expected to be measured had a physical smart pig been inserted into the pipeline. The predictions can be based on production conditions, historical results, and the well characteristics for the particular pipeline that is being evaluated. The predictions can be made on a quarterly basis, for example. Summaries of expected pipeline deterioration can be obtained periodically, e.g., quarterly. There are benefits from this approach including an up-to-date evaluation of the current corrosion expectations for the pipeline can be obtained without opening the pipeline to insert a smart pig. This timeliness ensures that situations for which the risk to pipeline integrity has increased will be detected quickly. Moreover, cost reductions will occur, because pipeline sections for which there is no expectation of significant corrosion or pitting will not need to be inspected according to a frequent schedule.

The predictive model will be described in terms of a modeling using a neural network, e.g., a multi-layer perceptron. However, this embodiment is merely exemplary and is not intended to limit the disclosure. Other types of modeling methods can be used, for example, a generalized linear model, multiple adaptive recursive splines, or, more generally, any computational model designed to predict continuous numerical outcomes.

If a neural network is used, the neural network can utilize a multi-layer percepteron, which can be represented as a nonlinear prediction equation. The neural perceptron has an input node for each of the predictors (parameters measured at blocks 38-41) in the neural network equation. Each of the input nodes can be connected to each of the hidden nodes by a weight. The number of hidden nodes can be specified as a control parameter. There is a constant, which is like the intercept in fitting a straight line that connects to each of the hidden nodes.

The neural network modeling can operate using numerical optimization, which begins from an initial set of random weights, and proceeds to an optimum set of weights through an iterative process that minimizes the sum of the squared errors for the differences between the observed log (wall loss due to corrosion) and the values estimated by the neural network. The mean square that is minimized can be the mean square for the test data, randomly selected from the data that is used by the neural network for fitting the data.

The objective in fitting the neural network can be to develop a good predictor, which is the one which has the largest correlation between the actual log (wall loss due to corrosion) values and the calculated log (wall loss due to corrosion) values for the validation data. As with any regression equation, the neural network can represent a mean value for all realizations at a specified set of inputs, where the minimum value for the data can be less than the minimum value for the fitted equation, and similarly, the maximum value for the data can be greater than the maximum value for the fitted equation. As with any regression equation, the neural network can represent a mean value for all realizations at a specified set of inputs. Then the minimum value for the data can be less than the minimum value for the fitted equation, and similarly for the maximum value.

Neural networks can be refined once created. The neural network will tend to yield the best results when used with the predictors having the most importance for the model. First, predictors can be varied across its range while the median value is used for all the other predictors. To determine a ranking of the predictor effects, the usual procedure for a neural network, varying one predictor while holding all the other predictors at a center value can be taken as the starting point. Second, some of the predictors can be highly pairwise correlated.

As the model is refined, the number and type of predictors can be reduced or eliminated to ensure that the model is no more complicated than necessary, but is robust enough to produce predictable results that have a high degree of accuracy and reliability. For example, predictors that rank lower in relevance to the determination of wall loss due to corrosion or maximum pit depth can be excluded from the model without loss of accuracy and reliability. For example, deletions can be made for predictors having effect values less than 0.2 on a scale from 0 to 1. In some instances, entire groups of categorical predictors can be dropped depending on their respective effect on the corrosion predictive ability. Predictors that are highly correlated with other predictors can be dropped.

At block 37, a first section of pipeline can be selected. The selection can be performed automatically, e.g., using a program to randomly select a portion, or can be performed manually, with a human user selecting the first section. The first section can be empirically measured using an actual smart pig or other manual inspection technique and the results are used to interpolate or extrapolate corrosion occurring in other parts of the same, or another, pipeline. That is, the methodology can include building a calibration between primarily actual inline inspection results and all the relevant predictive information (manual inspections can be used in the same way). Then the data, such as it might be for any other pipeline, can be entered and predictions can be made. In some embodiments, the steps depicted in blocks 37-41 can be performed repeatedly, in order to gather a plurality of measurements. These steps can be performed repeatedly in order to provide learning and validation data to a mathematical model.

At block 38, geometric configuration data for the first section of pipeline can be obtained. Typically, this step will be performed by consulting a database of pipeline data. A geographic information system (GIS) can be consulted at block 38. More particularly, the pipeline owner can retain a database of geographic and geometric data detailing the pipeline location and disposition. Included in this data, and relevant to block 38, are pipe circumference and pipe bend circumference. Other data include, e.g., numerical estimates of first and second path derivatives where the path follows the curvature of the pipeline, distances from significant features such as pipeline joints and supports, distances from geographic features such as road underpasses, etc. Other data that can be collected and used for the modeling process include, e.g., pressure, temperature and total mass flowrate. These data are gathered at block 38 and converted to a format suitable for use with a neural network.

At block 39, chemical composition data for the first pipeline section are obtained. These data may be obtained from a process database for the pipeline. In some embodiments, chemical makeup of the product flowing through the pipeline can be determined on a daily basis. These data can be converted to a format suitable for a neural network using known techniques.

At block 40, corrosion inhibition chemical composition data for the first pipeline section are obtained. Similar to block 39, these data can be obtained from a process database for the pipeline. In some embodiments, these data are tracked on a daily basis as such inhibition chemical are introduced into the pipeline. These data can be converted to a format suitable for use with a neural network using known techniques.

At block 41, data representing an internal pipeline deterioration are obtained. These data can be represented as, by way of non-limiting example, greatest depth of corrosion, average depth of corrosion or total mass of corrosion per unit pipeline length. A smart pig can be used to gather these data. These data can be gathered at the same time as the data gathered at blocks 38-40, or subsequent to the time that such data are gathered.

At block 42, a mathematical model can be formed. In the case of a neural network, this can include employing numerical optimization to minimize a sum of squared errors for differences between the observed data and the values estimated by the neural network. In some embodiments, the mathematical model can include a first principles multiphase flow model, which can generate an assessment of the localized flowing conditions as a way of contributing to the finer resolution of the influence of conditions on the corrosion state of the pipeline with position. Such flow conditions can include any, or a combination, of phase (oil, water, solid and gas), velocities, and flow regime, in addition to temperature and pressure.

At block 43, a second section of pipeline can be selected. The intent is that the second section of pipeline is to be assessed by the virtual smart pig model in order to determine whether it is likely sufficiently corroded so as to warrant physical inspection. Thus, data on the second section of pipeline can be collected, fed into the mathematical model, and an output of the model can be used to guide physical inspection. In some embodiments, the steps of blocks 43-49 are repeated a number of times for multiple pipeline sections. In such embodiments, only those sections that are indicated as likely being corroded are selected for physical inspection. That is, such embodiments can direct where in a pipeline portion to target the inspection, so the physical examination can be localized to quite a fine degree. In some such models, all, or substantially all section of the pipeline are selected for processing according to blocks 43-49. This provides a virtual smart pig that can assess an entire pipeline (or substantially all of the pipeline), even in situations where a physical smart pig cannot be introduced into the pipeline. The selection of block 43 can be performed automatically or manually.

At block 44, geometric configuration data for the second section of pipeline can be obtained. Similar to block 38, this step can be performed by consulting a database of pipeline data. A GIS can be consulted for pipe circumference, and pipe bend circumference, for example. Other data that can be collected and used for the evaluation process include, e.g., pressure, temperature and total mass flowrate. These data are gathered at block 44.

At blocks 45 and 46, respectively, chemical composition and chemical corrosion inhibition data are obtained for the second section of pipeline. As in blocks 39 and 40, respectively, these data can be obtained from obtained from a process database for the pipeline. In some embodiments, chemical makeup of the product flowing through the pipeline and corrosion inhibition introduction are determined on a daily basis. These data can be converted to a format suitable for use with a neural network using known techniques.

At block 46, the mathematical model can be executed with respect to the second section of pipeline. For embodiments that utilize a neural network, this can encompass evaluating the neural network's predictor equation. The output of such equation can indicate a second section of pipeline likely to be corroded to the extent that a physical inspection is warranted.

Thus, at block 48, a determination can be made as to whether the second section of pipeline is likely sufficiently corroded so as to warrant physical inspection. In some embodiments, this determination is largely, or totally, dependent on the outcome of block 47. In some embodiments, other information can be taken into account, such as the last date of physical inspection, for deciding on physical inspection. In some embodiments, particularly those that rely on probabilistic mathematical modeling, a threshold probability can be set such that physical inspection is warranted if the probability of corrosion is greater than the threshold. Such a threshold probability can be, by way of non-limiting example, 20%, 30%, 40%, 50%, 60%, 70%, 80%, 90% or 95%.

At block 49, the second section of pipeline can be physically inspected, if so indicated by block 48. The physical inspection can include partial disassembly of the selected section. The physical inspection can comprise insertion of a physical smart pig. Typically, physical inspection will reveal whether the section of pipeline should be repaired or replaced. The physical inspection can be purely confirmatory, in that plans and resources can be put in motion for a repair/replacement purely on the basis of the virtual assessment, particularly where confidence in that assessment had been demonstrated to meet a high degree of acceptability. Once physical inspection is performed, the actual corrosion data can be added to the mathematical model representing the second section of pipeline and used for future implementations.

While the present disclosure has been described according to its preferred embodiments, it is of course contemplated that modifications of, and alternatives to, these embodiments, such modifications and alternatives obtaining the advantages and benefits of this disclosure, will be apparent to those of ordinary skill in the art having reference to this specification and its drawings. It is contemplated that such modifications and alternatives are within the scope of this disclosure as subsequently claimed herein.

What is claimed is:

1. A computer-implemented method of selecting at least one portion of oil pipeline for physical inspection, the method comprising:
accessing a computer implemented mathematical model of a state of an oil pipeline, the mathematical model accepting as inputs at least geometric configuration data of a first section of oil pipeline, chemical composition data of a product flowing through the first section of oil pipeline, the chemical composition data reflecting at least each of a first plurality of days, chemical inhibition data of a corrosion inhibiting chemical introduced to the first section of oil pipeline, the chemical inhibition data reflecting at least each of the first plurality of days, and internal pipeline state data of the first section of oil pipeline, the internal pipeline state data reflecting a time subsequent to the first plurality of days;
collecting and electronically storing geometric configuration data of a second section of oil pipeline;
collecting and electronically storing chemical composition data of a product flowing through the second section of oil pipeline, the chemical composition data reflecting at least each of a second plurality of days;
collecting and electronically storing chemical inhibition data of a corrosion inhibiting chemical introduced to the second section of oil pipeline, the chemical inhibition data reflecting at least each of the second plurality of days;
inputting at least the geometric configuration data of the second section of oil pipeline, the chemical composition data of a product flowing through the second section of oil pipeline and the chemical inhibition data of a corrosion inhibiting chemical introduced to the second section of oil pipeline to the mathematical model;
executing the mathematical model to produce an estimate of an internal pipeline state of the second section of oil pipeline;
determining that the estimate of internal pipeline state of the second section of oil pipeline exceeds a threshold; and
physically inspecting the second section of oil pipeline in response to the determining.

2. The method of claim 1, wherein the first section of oil pipeline and the second section of oil pipeline are parts of different oil pipelines.

3. The method of claim 1, wherein the collecting and electronically storing internal pipeline state data of the first section of oil pipeline is performed using a smart inline inspection apparatus.

4. The method of claim 1, further comprising, for a plurality of sections of oil pipeline:
collecting and electronically storing geometric configuration data of each of the plurality of sections of oil pipeline;
collecting and electronically storing chemical composition data of a product flowing through each of the plurality of sections of oil pipeline;
collecting and electronically storing chemical inhibition data of a corrosion inhibiting chemical introduced to each of the plurality of sections of oil pipeline;
collecting and electronically storing internal pipeline state data of each of the plurality of sections of oil pipeline; and
inputting the geometric configuration data of each of the plurality of sections of oil pipeline, the chemical composition data of a product flowing through each of the plurality of sections of oil pipeline and the chemical inhibition data of a corrosion inhibiting chemical introduced to each of the plurality of sections of oil pipeline to the mathematical model.

5. The method of claim 1, wherein the mathematical model is selected from the group consisting of: a generalized linear model, a machine learning technique and a neural network.

6. The method of claim 5, wherein the mathematical model is an automated non-linear regression model.

7. The method of claim 5, wherein the mathematical model is a neural network and the neural network comprises a multi-layer percepteron.

8. The method of claim 7, wherein the multi-layer percepteron includes a nonlinear prediction equation.

9. The method of claim 1, further comprising:
collecting and electronically storing geometric configuration data of each of a plurality of sections of oil pipeline;
collecting and electronically storing chemical composition data of a product flowing through each of the plurality of sections of oil pipeline;
collecting and electronically storing chemical inhibition data of a corrosion inhibiting chemical introduced to each of the plurality of sections of oil pipeline;
inputting at least the geometric configuration data of each of the plurality of sections of oil pipeline, the chemical composition data of a product flowing through each of the plurality of sections of oil pipeline and the chemical inhibition data of a corrosion inhibiting chemical introduced to each of the plurality of sections of oil pipeline to the mathematical model;
executing the mathematical model to produce, for each of the plurality of sections of oil pipeline, an estimate of an internal pipeline state, whereby a plurality of estimates are produced;
determining that at least some of the plurality of estimates exceed a predetermined threshold; and
physically inspecting at least some sections of oil pipeline in response to the determining.

10. The method of claim 1, further comprising altering an amount of a corrosion inhibiting chemical in the second section of pipeline in response to the determining.

11. A system for selecting at least one portion of oil pipeline for physical inspection, the system comprising:
one or more central processing units for executing program instructions; and
at least one memory, coupled to at least one central processing unit, for storing a computer program including program instructions that, when executed by the one or more central processing units, causes the computer system to perform a sequence of operations for selecting at least one portion of oil pipeline for physical inspection, the sequence of operations comprising:
accessing a computer implemented mathematical model of a state of an oil pipeline, the mathematical model accepting as inputs at least geometric configuration data of a first section of oil pipeline, chemical composition data of a product flowing through the first section of oil pipeline, the chemical composition data reflecting at least each of a first plurality of days, chemical inhibition data of a corrosion inhibiting chemical introduced to the first section of oil pipeline, the chemical inhibition data reflecting at least each of the first plurality of days, and internal pipeline state data of the first section of oil pipeline, the internal pipeline state data reflecting a time subsequent to the first plurality of days;
accessing electronically stored geometric configuration data of a second section of oil pipeline;
accessing electronically stored chemical composition data of a product flowing through the second section of oil pipeline, the chemical composition data reflecting at least each of a second plurality of days;
accessing electronically stored chemical inhibition data of a corrosion inhibiting chemical introduced to the second section of oil pipeline, the chemical inhibition data reflecting at least each of the second plurality of days;
inputting at least the geometric configuration data of the second section of oil pipeline, the chemical composition data of a product flowing through the second section of oil pipeline and the chemical inhibition data of a corrosion inhibiting chemical introduced to the second section of oil pipeline to the mathematical model;
executing the mathematical model to produce an estimate of an internal pipeline state of the second section of oil pipeline; and
determining that the estimate of the internal pipeline state of the second section of oil pipeline exceeds a threshold.

12. The system of claim 11, wherein the first section of oil pipeline and the second section of oil pipeline are parts of different oil pipelines.

13. The system of claim 11, wherein the internal pipeline state data of the first section of oil pipeline is collected using a smart inline inspection apparatus.

14. The system of claim 11, wherein the sequence of operations further comprises:
collecting and electronically storing geometric configuration data of each of the plurality of sections of oil pipeline;
collecting and electronically storing chemical composition data of a product flowing through each of the plurality of sections of oil pipeline;
collecting and electronically storing chemical inhibition data of a corrosion inhibiting chemical introduced to each of the plurality of sections of oil pipeline;
collecting and electronically storing internal pipeline state data of each of the plurality of sections of oil pipeline; and
inputting the geometric configuration data of each of the plurality of sections of oil pipeline, the chemical composition data of a product flowing through each of the plurality of sections of oil pipeline and the chemical inhibition data of a corrosion inhibiting chemical introduced to each of the plurality of sections of oil pipeline to the mathematical model.

15. The system of claim 11, wherein the mathematical model is selected from the group consisting of: a generalized linear model, a machine learning technique and a neural network.

16. The system of claim 11, wherein the mathematical model is an automated non-linear regression model.

17. The system of claim 11, wherein the mathematical model is a neural network and the neural network comprises a multi-layer percepteron.

18. The system of claim 17, wherein the multi-layer percepteron includes a nonlinear prediction equation.

19. The system of claim 11, wherein the sequence of operations further comprises:
collecting and electronically storing geometric configuration data of each of a plurality of sections of oil pipeline;
collecting and electronically storing chemical composition data of a product flowing through each of the plurality of sections of oil pipeline;
collecting and electronically storing chemical inhibition data of a corrosion inhibiting chemical introduced to each of the plurality of sections of oil pipeline;
inputting at least the geometric configuration data of each of the plurality of sections of oil pipeline, the chemical composition data of a product flowing through each of the plurality of sections of oil pipeline and the chemical inhibition data of a corrosion inhibiting chemical introduced to each of the plurality of sections of oil pipeline to the mathematical model;
executing the mathematical model to produce, for each of the plurality of sections of oil pipeline, an estimate of an internal pipeline state, whereby a plurality of estimates are produced;
determining that at least some of the plurality of estimates exceed a predetermined threshold; and
physically inspecting at least some sections of oil pipeline in response to the determining.

20. The system of claim 11, wherein the sequence of operations further comprises altering an amount of a corrosion inhibiting chemical in the second section of pipeline in response to the determining.

21. A computer readable medium storing a computer program that, when executed on a computer system, causes the computer system to perform a sequence of operations for selecting at least one portion of oil pipeline for physical inspection, the sequence of operations comprising:
accessing electronically stored geometric configuration data of a first section of oil pipeline;
accessing electronically stored chemical composition data of a product flowing through the first section of oil pipeline, the chemical composition data reflecting at least each of a first plurality of days;
accessing electronically stored chemical inhibition data of a corrosion inhibiting chemical introduced to the first section of oil pipeline, the chemical inhibition data reflecting at least each of the first plurality of days;
accessing electronically stored internal pipeline state data of the first section of oil pipeline, the internal pipeline state data reflecting a time subsequent to the first plurality of days;
accessing an electronically stored mathematical model of a state of the first section of oil pipeline, the mathematical model accepting as inputs at least the geometric configuration data of the first section of oil pipeline, the chemical composition data of the product flowing through the first section of oil pipeline, the chemical inhibition data of the corrosion inhibiting chemical introduced to the first section of oil pipeline, and the internal pipeline state data of the first section of oil pipeline;
accessing electronically stored geometric configuration data of a second section of oil pipeline;
accessing electronically stored chemical composition data of a product flowing through the second section of oil pipeline, the chemical composition data reflecting at least each of a second plurality of days;
accessing electronically stored chemical inhibition data of a corrosion inhibiting chemical introduced to the second section of oil pipeline, the chemical inhibition data reflecting at least each of the second plurality of days;
inputting at least the geometric configuration data of the second section of oil pipeline, the chemical composition data of a product flowing through the second section of oil pipeline and the chemical inhibition data of a corrosion inhibiting chemical introduced to the second section of oil pipeline to the mathematical model;
executing the mathematical model to produce an estimate of an internal pipeline state of the second section of oil pipeline; and
determining that the estimate of the internal pipeline state of the second section of oil pipeline exceeds a threshold.
